(19) United States
(12) Patent Application Publication
(10) Pub. No.: US 2023/0356194 A1
(43) Pub. Date: Nov. 9, 2023

(54) Methods and Systems for Improving Catalytic Activities of Nanoparticles

(71) Applicant: The Board of Trustees of the Leland Stanford Junior University, Stanford, CA (US)

(72) Inventors: Matteo Cargnello, Stanford, CA (US); Weixin Huang, Stanford, CA (US)

(73) Assignee: The Board of Trustees of the Leland Stanford Junior University, Stanford, CA (US)

(21) Appl. No.: 18/247,237

(22) PCT Filed: Sep. 27, 2021
(86) PCT No.: PCT/US2021/071610

§ 371 Date: Mar. 29, 2023

Related U.S. Application Data
(60) Provisional application No. 63/084,847, filed on Sep. 29, 2020.

(51) Int. Cl. B01J 21/04; B01J 37/10; C01B 3/40; B01J 21/08; B01J 35/00; B01J 23/46

(52) U.S. Cl. CPC B01J 23/46; B01J 21/04; B01J 21/08; B01J 35/0013; B01J 35/006; B01J 37/10; C01B 3/40; C01B 2203/0261; C01B 2203/1064; C01B 2203/1082; C01B 2203/1241

(57) ABSTRACT

Many embodiments provide the formation of active Pd sites upon steam treatment. Steam treatment of Pd catalysts can improve redox combustion reaction efficiencies. Several embodiments provide the formation of twin boundaries under steam treatment can improve catalytic activities of nanoparticle catalysts.

### CROSS-REFERENCE TO RELATED APPLICATIONS

The current application claims the benefit of and priority to U.S. Provisional Patent Application No. 63/084,847 entitled “Promoting Catalytic Activity Through Stream Treatment-Induced Nanoparticle Restructuring” filed Sep. 29, 2020. The disclosure of U.S. Provisional Patent Application No. 63/084,847 is hereby incorporated by reference in its entirety for all purposes.

### FIELD OF THE INVENTION

The present invention generally relates to methods and systems for improving catalytic activity of nanoparticles; and more particularly to improving catalytic activity of nanoparticles through steam treatment.

### BACKGROUND OF THE INVENTION

Metal nanoparticles with different surface atomic arrangements can offer multiple catalytic sites with different binding configurations for reactants or intermediates, which could vary the catalytic activity. The catalytic activity of metal nanoparticles with different types of surface facets and defects (e.g., heteroatoms, grain boundaries, edges, etc.) can be potential candidates to advance catalytic activity.

### BRIEF SUMMARY OF THE INVENTION

Methods and systems for improving catalytic activities of nanoparticles are illustrated. Many embodiments provide that steam treatment can improve catalytic activities of nanoparticles. In several embodiments, steam treatment can induce nanoparticles restructuring and enhance catalytic activities. Defects may display high reactivity because the specific arrangement of atoms differs from crystalline surfaces. In many embodiments, steam with a water concentration of at least 0.8% (by volume) can be applied for the steam treatment. Some embodiments mix the steam in an inert gas including (but not limited to) argon gas to treat nanoparticles. In several embodiments, oxidation using a gas including (but not limited to) oxygen can be implemented during steam treatments. The steam treatments in accordance with some embodiments can take place at a temperature of at least 300° C. In a number of embodiments, nanoparticle catalysts comprise of precious metal including (but not limited to) palladium and/or platinum. Examples of nanoparticles include (but are not limited to): palladium (Pd) nanoparticles, palladium nanoparticles supported on alumina (Pd/Al₂O₃), palladium nanoparticles supported on silica, and platinum nanoparticles. Several embodiments implement steam treated nanoparticles as catalysts in redox reactions including (but not limited to) hydrocarbon redox reactions. Examples of hydrocarbon redox reactions include (but are not limited to): methane combustion reaction, propane combustion reaction.

Several embodiments provide that high-temperature steam treatments of nanoparticle catalysts can induce at least twelve-fold increase in reaction rate for redox reactions. In some embodiments, an increase in the grain boundary density through crystal twinning can be achieved during the steam pretreatment and oxidation. Several embodiments provide laser ablation can lead to redox reaction rate increases by introducing grain boundaries. The increase in the grain boundary density can be responsible for the increased catalytic reactivities. In many embodiments, high-temperature steam pretreatment of palladium catalysts can have at least twelve-fold increase in the mass-specific reaction rate for C—H activation in methane oxidation. The grain boundaries can be highly stable during reaction and show specific rates at least two orders of magnitude higher than other sites on the Pd/Al₂O₃ catalysts. Some embodiments provide that strain introduced by the defective structures can enhance C-H bond activation.

One embodiment of the invention includes a method to improve catalytic activity comprising providing at least one nanoparticle, and applying a steam from at least one steam source to the at least one nanoparticle at a temperature of at least 300° C. for at least 30 minutes, where the applied steam forms at least one twin boundary on the at least one nanoparticle, and the formation of the at least one twin boundary improves catalytic activity of the at least one nanoparticle.

In another embodiment, the at least one nanoparticle comprises palladium or platinum.

In a further embodiment, the at least one nanoparticle is selected from the group consisting of a palladium nanoparticle, a colloidal palladium nanoparticle, a palladium nanoparticle supported on alumina, a palladium nanoparticle supported on silica, and a platinum nanoparticle.

In an additional embodiment, the at least one nanoparticle has a diameter from about 4 nm to about 15 nm.

In a further still embodiment, the steam has a water concentration of at least 0.8% by volume.

In another yet embodiment, the steam has a water concentration of about 0.8% by volume, of about 4% by volume, or of about 10% by volume.

In a yet further embodiment again, the steam is mixed with an inert gas.

In still another embodiment, the steam is applied at about 600° C. for about 30 minutes.

A further additional embodiment includes comprising applying an oxygen gas to the steam treated at least one nanoparticle.

In a still yet further embodiment, the steam treated at least one nanoparticle is a catalyst in a redox reaction.

In yet another embodiment again, the steam treated at least one nanoparticle is a catalyst in a hydrocarbon combustion reaction.

In a still further embodiment, the catalyst improves mass-specific reaction rate for C—H activation in a methane combustion reaction by at least 12 times.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 illustrates a HAADF-STEM image of pristine Pd nanoparticles on alumina support in accordance with embodiments.

FIGS. 2A - 2C illustrate methane combustion light-off curves of Pd/Al₂O₃ treated in steam at different temperatures, different atmospheres, and in oxygen at different temperature respectively in accordance with embodiments.

FIG. 3 illustrates cyclic stability test of steam-pretreated Pd/Al₂O₃ for methane combustion in accordance with embodiments.

FIG. 4A illustrates methane combustion light-off curves of Pd/Al₂O₃ pretreated in 0.8%, 4% and 10% (by volume) steam at about 600° C. in accordance with embodiments.

FIG. 4B illustrates methane combustion light-off curves of Pd/Al₂O₃ pretreated with steam at 600° C. for 0.5 and 2 hours in accordance with embodiments.

FIGS. 5A - 5D illustrate HAADF-STEM images of (A) Pd/Al₂O₃ pretreated in steam at about 600° C., (B) Pd/Al₂O₃ pretreated in O₂ and H₂ sequentially at about 600° C., (C) Pd/Al₂O₃ pretreated in O₂ at about 600° C., and (D) particle size distributions of these samples in accordance with embodiments.

FIG. 6 illustrates Pd 3d photoelectron spectra of Pd/Al₂O₃ after O₂ at about 600° C., O₂—H₂, steam at about 600° C., and steam-O₂ pretreatments in accordance with embodiments.

FIGS. 7A - 7B illustrate light-off curves and T₅₀ values of Pd/Al₂O₃ after O₂ at about 600° C., O₂—H₂, steam at about 600° C., and steam-O₂ pretreatments in accordance with embodiments.

FIG. 8 illustrates Arrhenius plots of methane combustion on Pd/Al₂O₃ after O₂—H₂ pretreatment and steam pretreatment in accordance with embodiments.

FIGS. 9A - 9B illustrate CH₄-TPR and O₂-TPO profiles of Pd/Al₂O₃ catalysts after steam or O₂ pretreatments in accordance with embodiments.

FIGS. 10A - 10B illustrate methane combustion light-off curves and T₅₀ values of Pd(8 nm)/Al₂O₃ catalysts prepared on conventional Al₂O₃ and steam-pretreated Al₂O₃ in accordance with embodiments.

FIG. 11 illustrates methane combustion light-off curves of Pd/SiO₂ catalysts after pretreatment in O₂, O₂ followed by H₂, and steam at about 600° C. in accordance with embodiments.

FIGS. 12A - 12C illustrate atomic-resolution HAADF-STEM images of (A) steam-pretreated Pd/Al₂O₃, (B) O₂—H₂—pretreated Pd/Al₂O₃, (C) CO—O₂—H₂—pretreated Pd/Al₂O₃ in accordance with embodiments.

FIG. 13 illustrates detailed arrangements of Pd atoms in accordance with embodiments.

FIG. 14 illustrates TB density statistical histogram of Pd/Al₂O₃ after steam, O₂—H₂, and CO—O₂—H₂ treatment in accordance with embodiments.

FIG. 15 illustrates light-off curves of Pd/Al₂O₃ after steam, O₂—H₂ and CO—O₂—H₂ pretreatments in accordance with embodiments.

FIG. 16 illustrates relationship between reaction rate/T₅₀ and TB density in accordance with embodiments.

FIG. 17 illustrates strain mapping for an individual Pd NP in the stream-pretreated catalyst relative to the reference values in the horizontal direction in accordance with embodiments.

FIGS. 18A - 18C illustrate environmental TEM (E-TEM) images of the Pd nanoparticle in the steam-pretreated Pd/Al₂O₃ sample exposed to O₂ at around 23° C. and around 500° C. in accordance with embodiments.

FIGS. 19A - 19C illustrate (A) potential energy diagram for O₂ dissociation on Pd (111) and on a TB model; (B) Top views of the energetically preferred initial (IS), transition (TS), and final (FS) states in the NEB calculations used to prepare the potential energy diagram on the left; (C) Top and side views of the TB model in accordance with embodiments.

FIGS. 20A - 20C illustrate (A) TEM images of 8 nm Pd nanoparticles; (B) methane combustion light-off curves for 8 nm Pd/Al₂O₃ catalysts, after different pretreatments; (C) Arrhenius plots of dry combustion kinetics for Pd/Al₂O₃ catalysts after pretreatment in O₂ and steam at 600° C. in accordance with embodiments.

FIGS. 21A - 21C illustrate (A) TEM images of 12 nm Pd nanoparticles; (B) methane combustion light-off curves for 12 nm Pd/Al₂O₃ catalysts, after different pretreatments; (C) Arrhenius plots of dry combustion kinetics for Pd/Al₂O₃ catalysts after pretreatment in O₂ and steam at 600° C. in accordance with embodiments.

FIG. 22 illustrates increase in reaction rates for Pd/Al₂O₃ catalysts with nanoparticle size in accordance with embodiments.

FIGS. 23A - 23C illustrate (A) TEM image of laser ablation-generated Pd NPs; (B) GB density statistical histogram of laser-generated Pd/Al₂O₃ and Pd/Al₂O₃ after steam and O₂—H₂ pretreatments; (C) Arrhenius plots of methane combustion of laser-generated Pd/Al₂O₃ and Pd/Al₂O₃ after steam and O₂—H₂ pretreatments in accordance with embodiments.

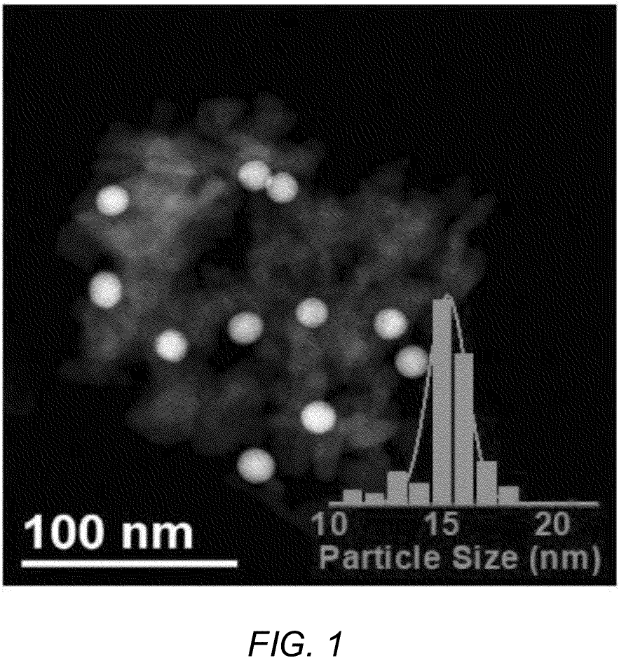

### DETAILED DESCRIPTION OF THE INVENTION

Turning now to the drawings, methods and systems utilizing steam treatments to improve catalytic activities of nanoparticles, are described. Many embodiments provide restructuring nanoparticles by high-temperature steam treatments. A number of embodiments utilize nanoparticle catalysts comprising of precious metal including (but not limited to) palladium and/or platinum. In some embodiments, examples of nanoparticles include (but are not limited to): palladium (Pd) nanoparticles, palladium nanoparticles supported on alumina (Pd/Al₂O₃), palladium nanoparticles supported on silica (SiO₂), and platinum nanoparticles. Several embodiments provide the formation of active sites including (but not limited to) twin boundaries (TBs) and grain boundaries (GBs) in nanoparticles upon steam treatments can induce catalytic activities increase. Several embodiments provide that a higher twin boundary density can induce higher catalytic activities of nanoparticles. Some embodiments provide improved catalytic activities of steam treated nanoparticles in redox reactions including (but not limited to): hydrocarbon redox reactions. Examples of hydrocarbon redox reactions include (but are not limited to): methane combustion reactions, propane combustion reactions. Several embodiments provide improved nanoparticle catalytic activities in methane combustion reactions. Some embodiments provide that nanoparticle catalysts can improve redox reaction rate by at least 12 times. A number of embodiments provide nanoparticle catalysts can be applied in various gas industry applications where NOₓ and SOₓ emissions could be reduced in operations.

Several embodiments provide T₅₀ values, temperatures needed to achieve 50% conversion of CH₄ to CO₂ can be used to evaluate catalytic activities of nanoparticles in methane combustion reactions. Many embodiments C₃H₈ conversion efficiency to evaluate nanoparticle catalytic activities in propane combustion reactions. In a number of embodiments, steam pretreatments of nanoparticle catalysts have a lower T₅₀ than pretreatments with gases including (but not limited to) oxygen, hydrogen, and argon. The lower the T₅₀ of CH₄ conversion, the higher conversion efficiency of the catalysts. Some embodiments provide that steam treatments of nanoparticle catalysts around at least 600° C. have a lower T₅₀ than steam treatments from about 300° C. to about 500° C. Many embodiments provide that oxygen treatments of nanoparticles at elevated temperatures from about 300° C. to about 600° C. almost do not change T₅₀ of CH₄ conversion.

In many embodiments, palladium colloidal nanoparticles (NPs) can be obtained via the reduction of palladium (II) acetylacetonate (Pd(acac)₂) in mixtures of high-boiling-point solvents including (but not limited to) octadecene (ODE) and tetradecene (TDE) at elevated temperatures with reducing agent including (but not limited to) trioctylphosphine (TOP) and surfactant including (but not limited to) oleylamine (OAm). The Pd nanoparticles can have a support material including (but not limited to) alumina and silica.

In many embodiments, steam treatment can improve catalytic activities of nanoparticles of various sizes. Palladium nanoparticles with a diameter ranging from about 4 nm to about 15 nm exhibit catalytic activities increase in redox reactions after steam treatment. Examples of nanoparticles include (but are not limited to): Pd/Al₂O₃ catalysts prepared with colloidal Pd NPs with an average diameter from about 4 nm, about 8 nm, about 12 nm, and about 15 nm. Some embodiments provide steam pretreatment-induced activity increase in Pd/Al₂O₃ catalysts prepared by wet impregnation processes. Several embodiments provide the steam-pretreated catalysts exhibit higher activity than the O₂-pretreated catalysts. The NPs with a larger size have greater improvement in methane combustion rates upon the steam treatment in accordance with some embodiments. Certain embodiments provide that the more energetically favorable formation of TBs in larger NPs may be able to more easily accommodate defects.

In certain embodiments, steam with a water concentration of at least 0.8% (by volume) can be used to treat nanoparticles. In certain embodiments, the water concentration of steam can be from about 4% to about 10%. In a number of embodiments, steam mixed in an inert gas including (but not limited to) argon gas can be used to treat nanoparticles and improve catalytic activities. Several embodiments provide that nanoparticles can retain the catalytic activities after at least 5 cycles of steam treatment. Many embodiments provide the formation of twin boundaries and/or grain boundaries in the nanoparticle catalysts. In many embodiments, steam treatments can be carried out at a temperature of at least 300° C. In various embodiments, steam treatments can be carried out at a temperature of at least 500° C. In a number of embodiments, steam treatments can be carried out at least 600° C. Several embodiments provide that steam treatments on nanoparticles can last for at least 30 minutes. In many embodiments, steam pretreatments can be carried out at least 300° C. for at least 30 minutes. Some embodiments provide steam treatments at around 600° C. for about 30 minutes under about 4.2% (by volume) steam in Ar. The steam can be generated with a Ar-flow rate about 25 ml min⁻¹ through a saturator with water including (but not limited to) Milli-Q water at a water temperature at about 30° C. The concentration of steam can be controlled by adjusting the saturator temperature in accordance with some embodiments. In a number of embodiments, 0.8% (by volume) and 10% (by volume) steam can be achieved by cooling and heating the saturator at about 4° C. and about 47° C., respectively.

Many embodiments provide formation of TBs and/or GBs can act as highly active sites for methane combustion. The formation of TBs and/or GBs in accordance with some embodiments provides the opportunity to engineer nanoparticle catalysts for improved reactivity if the density of such defects can be increased. Several embodiments provide laser ablation processes can be used to fabricate NPs catalysts rich in GBs. NPs including (but not limited to) Pd/Al₂O₃ catalysts can be prepared by depositing colloidal NPs on the alumina support. Certain embodiments provide that the turnover frequency (TOF) of the laser ablation-generated Pd/Al₂O₃ catalysts can be at least 4 times higher than that of the steam-pretreated Pd/Al₂O₃ catalyst, and nearly 25 times higher than a catalyst pretreated in oxygen and hydrogen.

### Improving Catalytic Activities of Pd Nanoparticles Via Steam Treatment

The catalytic activities of supported metal nanoparticles (NPs) can depend on their surface structure and the exposed surface sites. Specific types of surface sites, such as terrace sites, steps, grain boundaries, and metal-support interface sites, can be manipulated to improve catalytic activity. For instance, tetrahexahedral platinum (Pt) NPs with high-index facets exhibited enhanced catalytic activity in electro-oxidation of formic acid and ethanol compared to Pt nanospheres. (See, e.g. N. Tian, et. al, Science, 2007, 316, 732-735, the disclosure of which is herein incorporated by reference). A silver catalyst with a high density of stacking faults showed superior activity and durability in the hydrogen evolution reaction. (See, e.g. Z. Li, et. al, Nat. Catal., 2019, 2, 1107-1114, the disclosure of which is herein incorporated by reference).

TBs and GBs may be some of the most stable defects on metal surfaces and can be the active sites in certain electrocatalytic reactions (e.g. CO₂ electroreduction). The improvement in performance can be resulted from the lattice strain induced by structural perturbations in the vicinity of the GBs at the catalyst surface, and this effect can lead to orders of magnitude higher catalytic rates. Although GBs have been recognized as promising defects for the activity of electrocatalysts, little is known about how they alter the catalytic properties in gas-phase heterogeneous reactions.

Many embodiments provide that steam pretreatments of Pd nanoparticles including (but not limited to) Pd/Al₂O₃ nanoparticles can enhance the catalytic activities in methane combustion reactions. In several embodiments, the mass-specific reaction rate of methane combustion reactions can increase by at least 12 times using steam pretreated Pd nanoparticles, compared to the same samples treated in O₂. The extent of formation of TBs and GBs in accordance with certain embodiments can be correlated with the improved activities of the Pd based catalysts. Some embodiments provide that surface strain present in the immediate vicinity of GBs can induce changes in reactivities. The specific active sites may exhibit a two orders of magnitude higher intrinsic rate.

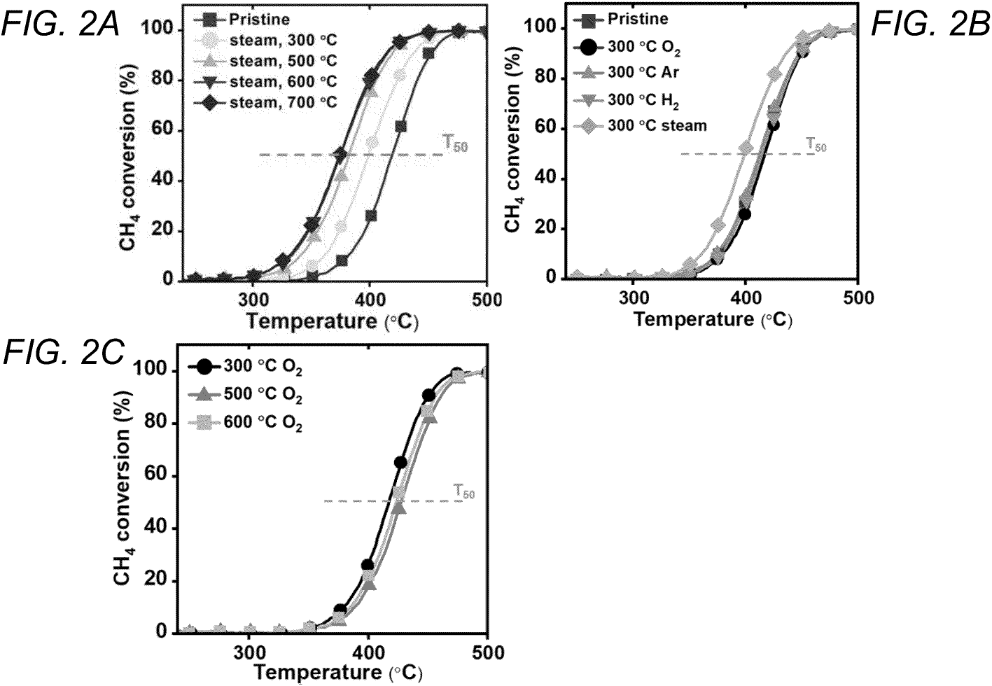

In several embodiments, uniform colloidal Pd nanoparticles (NPs) can be deposited onto a Al₂O₃ support (Pd/Al₂O₃). The average diameter of Pd NPs can be about 15 nm. The Pd NPs can have diameters with a Gaussian distribution centered around 15 nm. A HAADF-STEM image of pristine Pd/Al₂O₃ NPs in accordance with an embodiment is illustrated in FIG. 2. The size distribution represents the sizes of Pd NPs.

Some embodiments provide that the catalytic activities of the Pd/Al₂O₃ NP catalysts can be evaluated for methane combustion with steam treatments at various temperatures and/or with different gas treatments. The Pd/Al₂O₃ NP catalysts can be ramped from about 150° C. to determine the light-off temperature. Gas pretreatment of Pd/Al₂O₃ NP catalysts can include steam, O₂, H₂, and Ar, at temperatures of at least 300° C. Methane combustion efficiency for the pristine Pd/Al₂O₃ NP catalysts after steam treatments at various temperatures and after several gas pretreatments in accordance with an embodiment of the invention is illustrated in FIGS. 2A - 2C. Methane combustion efficiency is measured as to achieve about 50% conversion of CH₄ to CO₂ (T₅₀ values). FIG. 2A illustrates light-off curves for methane combustion (about 0.4% CH₄, 4.0% O₂, 4.2% H₂O, balance Ar) on pristine Pd/Al₂O₃ and after pretreatment in steam at increasing temperatures. In FIG. 2A, catalytic activities of Pd/Al₂O₃ NP catalysts improve with increasing pretreatment temperature up to about 600° C. and show almost no change at about 700° C. For Pd/Al₂O₃ NP catalysts, a T₅₀ of about 373° C. can be achieved with steam pretreatments around at least 600° C.

FIG. 2B illustrates methane combustion light-off curves of Pd/Al₂O₃ pretreated in different atmospheres of O₂, H₂, Ar, and steam at about 300° C. After a pretreatment in steam at about 300° C., the Pd/Al₂O₃ catalyst shows a noticeable improvement in catalytic activity that has a lowest T₅₀ value. Negligible changes in light-off curves can be observed relative to the pristine catalyst after pretreatments in atmospheres of O₂, H₂, and Ar. Pd/Al₂O₃ pretreated in atmospheres of O₂, H₂, and Ar show similar T₅₀ temperatures of about 423° C.

FIG. 2C illustrates methane combustion light-off curves of Pd/Al₂O₃ pretreated at 300° C., 500° C. and 600° C. in O₂ No catalytic enhancement can be observed for the catalyst pretreated in O₂ treated at increasing temperatures (300, 500, and 600° C.). In comparison, Pd/Al₂O₃ catalytic activity improves with treatment in steam with increasing temperatures. A T₅₀ of about 373° C. can be achieved after steam treatment, which is about 50° C. lower than the Pd/Al₂O₃ catalyst treated in oxygen.

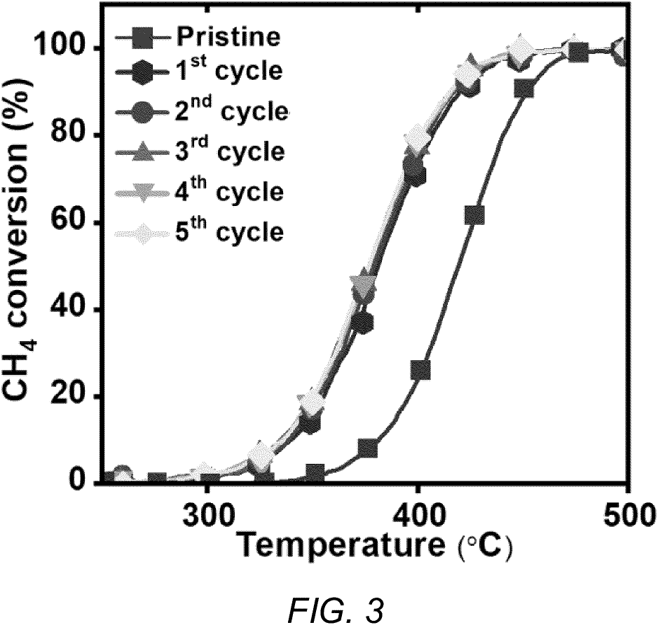

Many embodiments provide that Pd nanoparticles can remain stable catalytic activities after at least 5 cycles of steam treatment. Co-feeding of steam in the reaction mixture usually may have a detrimental effect on the methane combustion activity of Pd catalysts, however the steam pretreatment could increase the activity of the Pd catalyst. A cyclic stability test of steam-pretreated Pd/Al₂O₃ for methane combustion in accordance with an embodiment is illustrated in FIG. 3.The higher performance after steam pretreatment can be stable for at least five cycles (5 hours spent on stream), as shown in FIG. 3.

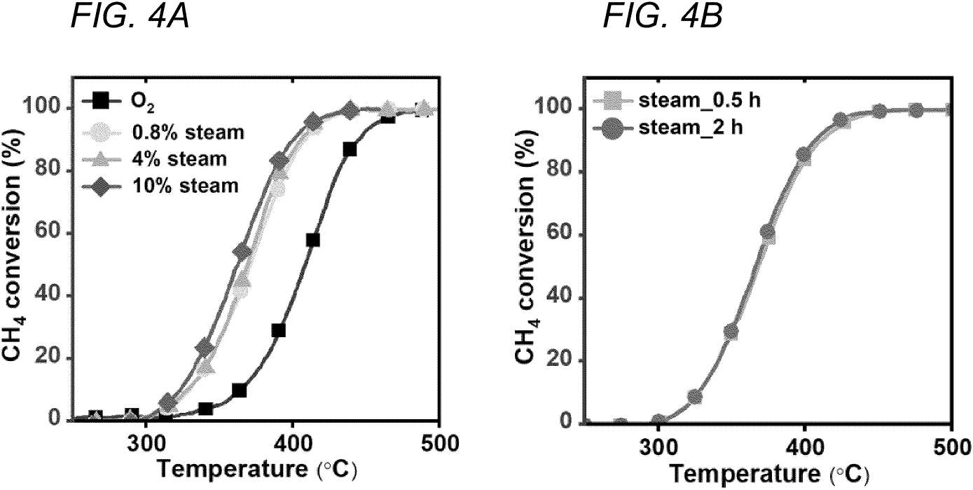

Some embodiments provide that the pretreatment temperatures can be more important than treatment duration and steam concentration in improving catalytic activities of Pd catalysts. Several embodiments provide the variability in steam concentration and processing time during the pretreatment of Pd catalysts. Methane combustion light-off curves of Pd/Al₂O₃ pretreated in 0.8%, 4% and 10% (by volume) steam at 600° C., respectively in accordance with an embodiment is illustrated in FIG. 4A. The improved activity can be achieved at a water concentration as low as 0.8 % (by volume) and may not change at increasing concentrations (4% and 10%). Methane combustion light-off curves of Pd/Al₂O₃ pretreated with steam at 600° C. for 0.5 and 2 hours in accordance with an embodiment is illustrated in FIG. 4B. Changing the pretreatment duration from about 0.5 hour to about 2 hour almost does not change T₅₀.

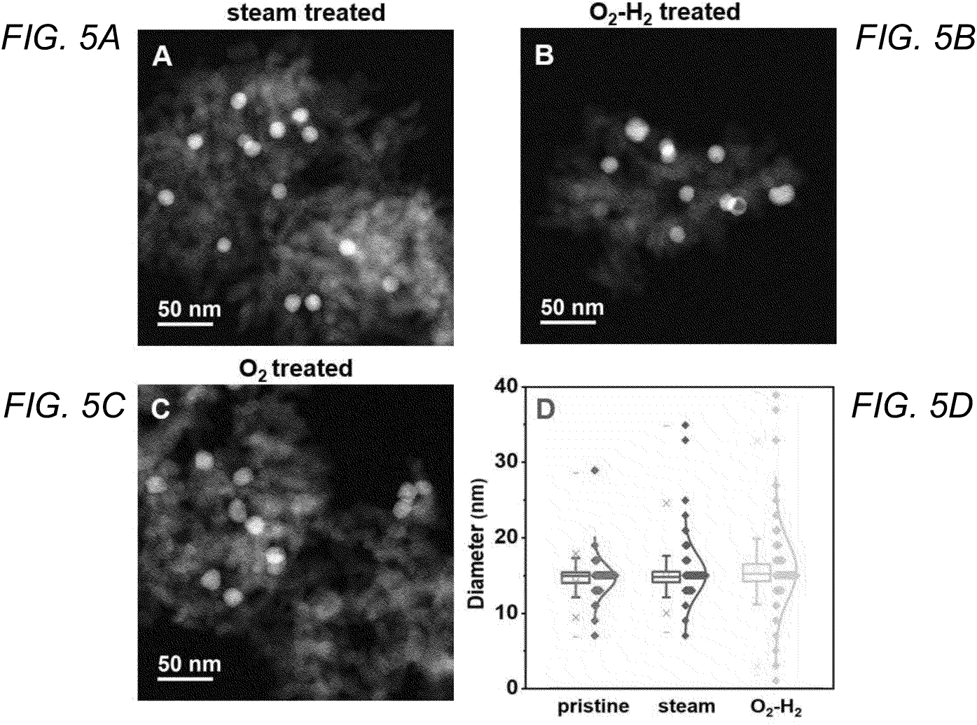

In many embodiments, high-angle annular dark-field scanning transmission electron microscopy (HAADF-STEM) analysis show that there is no appreciable change in NP size distributions after the steam treatments. Several embodiments provide that the improved catalytic activities may not be the results of particle sintering and/or redispersion. HAADF-STEM images of Pd/Al₂O₃ pretreated in different atmospheres at about 600° C., and particle size distributions in accordance with an embodiment are illustrated in FIGS. 5A - 5D. FIG. 5A illustrates HAADF-STEM images of Pd/Al₂O₃ pretreated in steam at about 600° C. FIG. 5B illustrates HAADF-STEM images of Pd/Al₂O₃ pretreated in O₂ and H₂ sequentially at about 600° C. FIG. 5C illustrates HAADF-STEM images of Pd/Al₂O₃ pretreated in O₂ at about 600° C. FIG. D illustrates particle size distributions of these samples. The particle sizes are in a similar range after different pretreatment atmospheres.

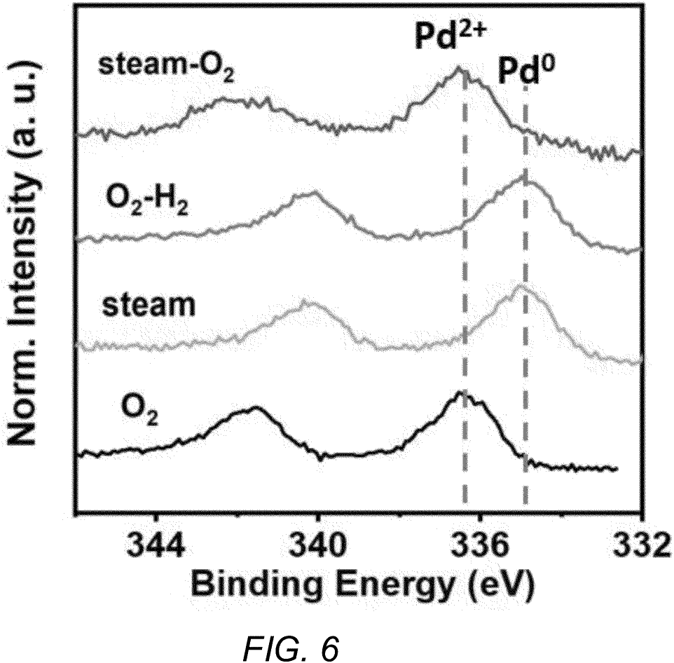

Pd 3d photoelectron spectra of Pd/Al₂O₃ after O₂ (600° C.), O₂—H₂, steam (600° C.), and steam-O₂ pretreatments in accordance with an embodiment is illustrated in FIG. 6. X-ray photoelectron spectroscopy (XPS) measurements show that in the O₂-pretreated catalyst, Pd 3d_{5/2} peak is located at around 336.6 eV as shown in FIG. 6, consistent with PdO phase. The steam-pretreated catalyst exhibits the peak at around 335.0 eV attributable to metallic Pd(0), which is consistent with x-ray diffraction (XRD).

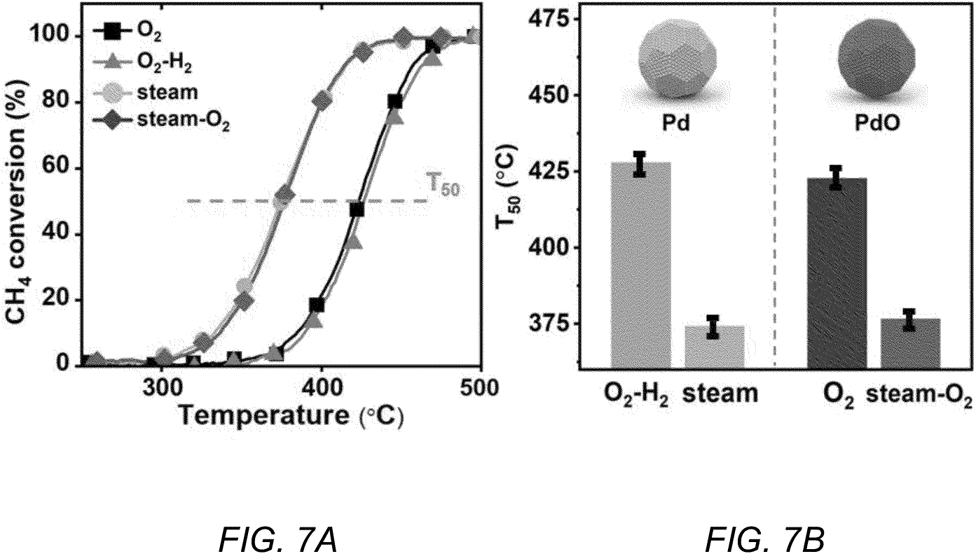

Many embodiments compare Pd/Al₂O₃ catalysts with similar oxidation states. Several embodiments provide that the initial Pd oxidation state before catalysis may not correlate with the methane oxidation activity of the samples, and steam pretreatment can improve the Pd activity regardless of its initial oxidation state. Light-off curves and T₅₀ values of Pd/Al₂O₃ after different treatment atmospheres in accordance with an embodiment of the invention are illustrated in FIG. 7A and FIG. 7B respectively. FIG. 7A illustrates light-off curves of Pd/Al₂O₃ after O₂ at about 600° C., O₂—H₂, steam at about 600° C., and steam-O₂ pretreatments. FIG. 7B illustrates T₅₀ values of Pd/Al₂O₃ after O₂—H₂, steam at about 600° C., O₂ at about 600° C., and steam-O₂ pretreatments. Error bars represent the minimum and maximum measured values of at least three repeated experiments. The Pd/Al₂O₃ sample can be prepared through sequential oxygen and hydrogen treatments (labeled as O₂—H₂—pretreated Pd/Al₂O₃) to convert the Pd oxide phase into metallic Pd. However, the activity for O₂—H₂—pretreated Pd/Al₂O₃ is similar to the one pretreated exclusively in O₂ and much lower than the steam-pretreated catalyst (FIGS. 7A and 7B). The steam-pretreated sample can be followed with an oxygen treatment (labeled as steam-O₂-pretreated Pd/Al₂O₃) to convert the metallic Pd phase into PdO. The oxidation appears not to reduce the activity of the steam-O₂-pretreated Pd/Al₂O₃ compared to the steam-pretreated sample (FIGS. 7A and 7B).

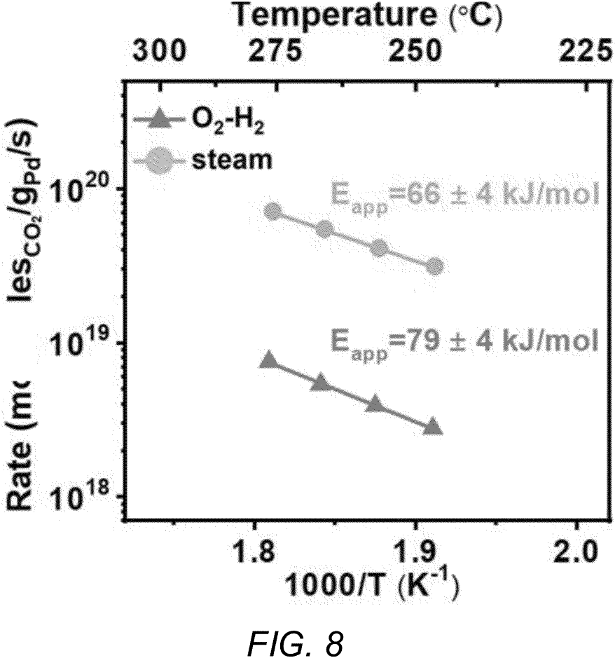

Some embodiments provide the reaction rates of various Pd/Al₂O₃ catalysts. Steam may not be added to the reaction mixture to avoid catalyst changes during kinetic experiments. Arrhenius plots of methane combustion on Pd/Al₂O₃ after O₂-H₂ pretreatment and steam pretreatment in accordance with an embodiment is illustrated in FIG. 8. Pd/Al₂O₃ catalysts are pretreated in O₂—H₂ and steam respectively at about 600° C. As shown in FIG. 8, the 600° C. steam-pretreated catalyst has about 12 times higher mass-specific rate than the O₂—H₂—pretreated catalyst. Activating the first C—H bond can be recognized as the rate-limiting step in methane oxidation, and Arrhenius plots shows an activation energy for the O₂—H₂—pretreated catalyst of about 79 ± 4 kJ·mol⁻¹. The steam-pretreated catalyst has a lower activation energy of about 66 ± 4 kJ·mol⁻¹. The two samples show similar values of the pre-factor (about 3 × 10²⁶ molecules_{co2}/g_{Pd}/s).

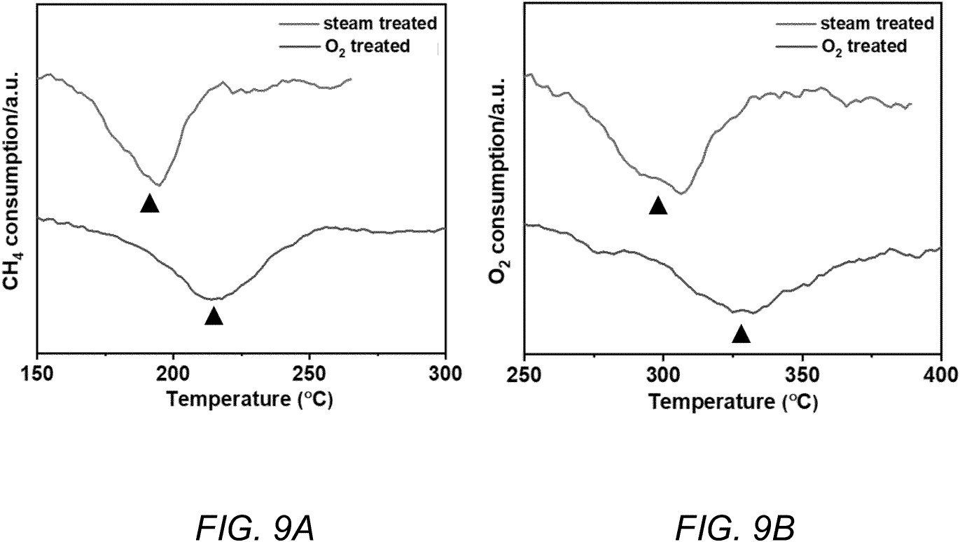

In many embodiments, the Pd phase in the steam-pretreated catalyst can be more easily oxidized and reduced by O₂ and CH₄, respectively, and could be more active in methane oxidation. CH₄-TPR and O₂-TPO profiles of Pd/Al₂O₃ catalysts after steam or O₂ pretreatments in accordance with an embodiment is illustrated in FIG. 9A and FIG. 9B respectively. Triangles indicate the peak centers of reduction or oxidation temperatures measured by equally dividing the peak area. The effect of PdO reducibility state is explored with methane temperature-programmed reduction as CH₄-TPR in FIG. 9A. Whereas methane oxidation is observed at around 190° C. for the steam-pretreated catalyst, the temperature shifts up to about 215° C. for the O₂-pretreated catalyst. In temperature-programmed Pd oxidation (O₂-TPO) experiments as shown in FIG. 9B, O₂ uptake is at about 295° C. for the steam-pretreated catalyst versus about 330° C. for the O₂-pretreated one.

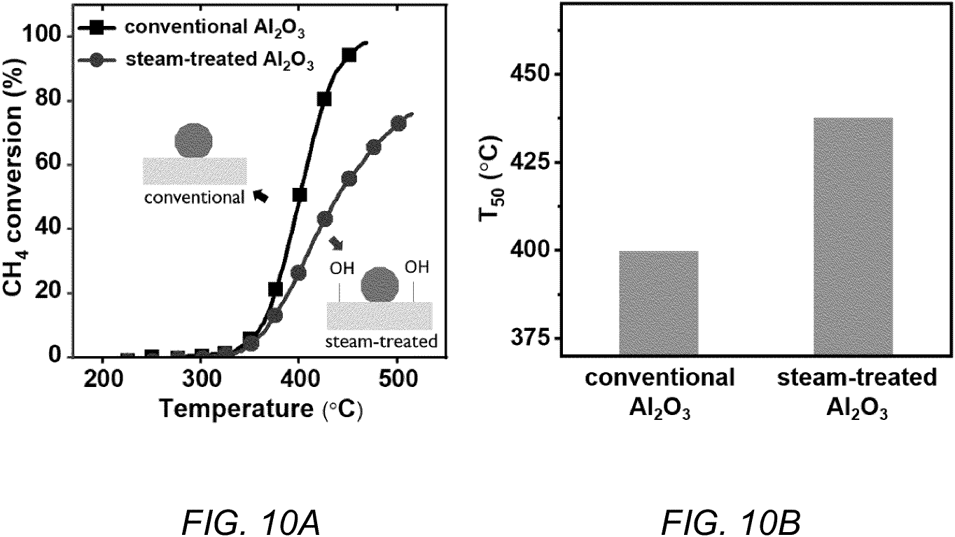

Many embodiments provide that changes in the support materials of the nanoparticle catalysts after steam treatment, including (but not limited to) support hydroxylation, may promote reactivity of supported metal phases. In several embodiments, the alumina support can be treated in steam before depositing Pd NPs. The steam pretreated alumina support shows a higher T₅₀ than that of conventional Pd/Al₂O₃ with the same NP size. The decreased activity could have been caused by different metal-support interactions with hydroxylated alumina. Methane combustion light-off curves and T₅₀ values of Pd/Al₂O₃ catalysts prepared on conventional Al₂O₃ and steam-pretreated Al₂O₃ in accordance with an embodiment is illustrated in FIG. 10A and FIG. 10B respectively.

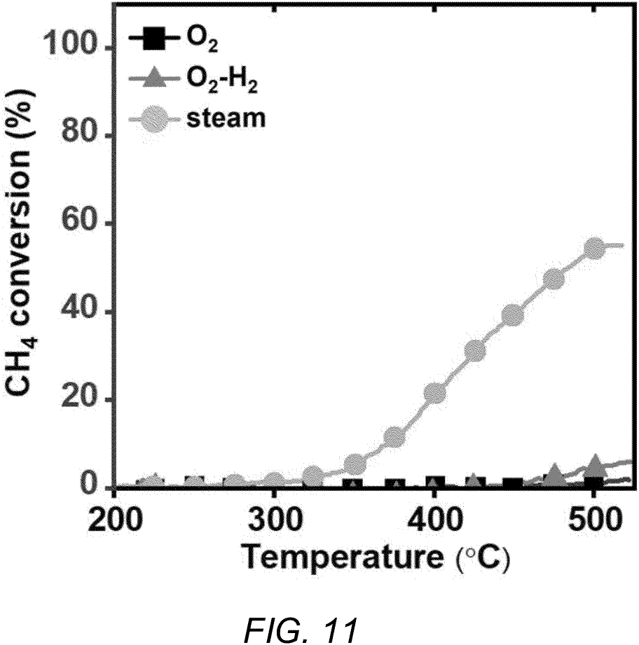

In some embodiments, Pd/SiO₂ catalysts may exhibit similar improvement in catalytic activities when treated in steam versus oxygen or oxygen-hydrogen atmospheres. Methane combustion light-off curves of Pd/SiO₂ catalysts after pretreatment in O₂, O₂ followed by H₂, and steam at 600° C. in accordance with an embodiment of the invention is illustrated in FIG. 11. Activity improvement could result from catalyst synthesis by-products being removed from the surface by the steam treatment. Phosphorus can be an impurity in the initial Pd NPs. However, it can be mostly removed after steam or O₂—H₂ treatments. A number of embodiments provide that activity enhancement of nanoparticle catalysts can be related to structural changes in the Pd NPs.

### Twin Boundaries Formation in Pd Nanoparticles

HAADF-STEM can be used to characterize the structure of the supported metallic Pd NPs in accordance with some embodiments. The pristine Pd NPs on alumina mostly have an amorphous structure. However, after being treated in steam or O₂—H₂, the NPs can crystallize and become highly faceted. Oxidized Pd NPs can undergo drastic electron-beam induced changes and may not be shown.

Many embodiments provide that different Pd exposed facets upon different gas pretreatments could account for the changes in reactivity. The distances from the particle center to the outermost surface planes can be measured, and the corresponding three-dimensional crystal shape can be derived by using the Wulff construction. From the Wulff shape, the occurrence of different types of surface facets can be extracted. Although samples show different fractions of exposed facets, no trend can be correlated with the difference in catalyst activity, nor does the presence of voids in the NPs created by Kirkendall effects. A similar procedure can be used to analyze oxidized NPs, and although the beam sensitivity allows measurements of few of them, comparable ratios of PdO {110} and {101} facets may be observed.

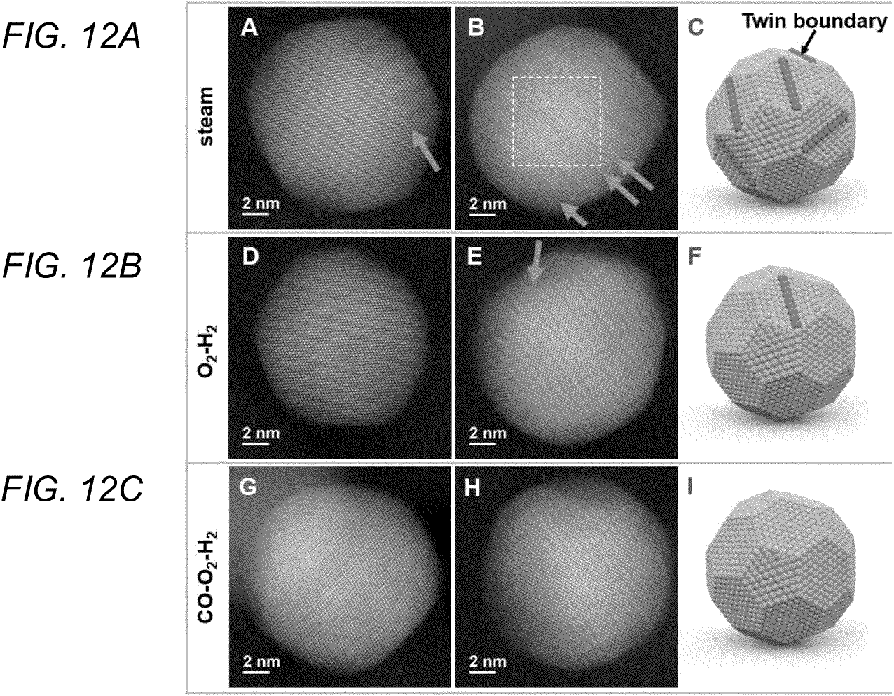

Atomic-resolution HAADF-STEM images of steam-pretreated Pd/Al₂O₃ at about 600° C., O₂—H₂—pretreated Pd/Al₂O₃, CO—O₂—H₂—pretreated Pd/Al₂O₃, and the schematics of the TB density change in respective Pd NPs after different gas pretreatments in accordance with an embodiment of the invention are illustrated in FIGS. 12A - 12C. Both the steam- and O₂—H₂—pretreated samples exhibit TBs that lay parallel to {111} planes (also referred to as Σ3 {111} TBs, arrows in FIGS. 12A and 12B. The CO—O₂—H₂—pretreated Pd/Al₂O₃ sample in FIG. 12C does not show TBs. Separated by a coherent TB, the surface structure shows a symmetrical lattice arrangement with an ABC|CBA stacking sequence.

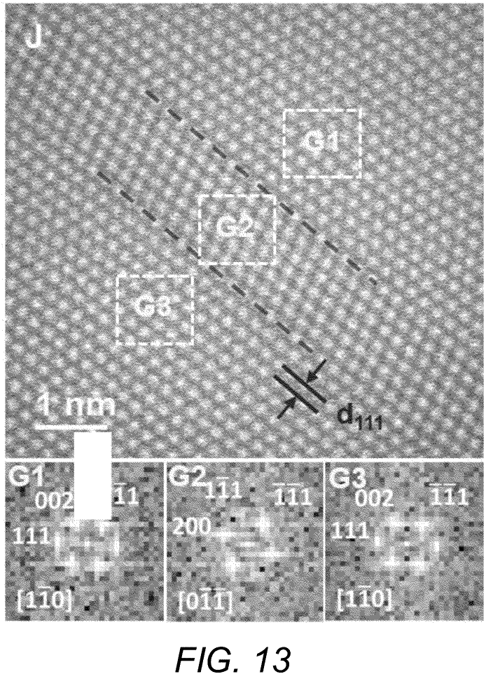

The fast Fourier-Transform (FFT) diffractograms of steam-pretreated Pd/Al₂O₃ at about 600° C. in accordance with an embodiment is illustrated in FIG. 13. FIG. 13 reveals the detailed arrangements of Pd atoms. The dash lines highlight Σ3{111} TBs. Corresponding FFT images of grains (G1, G2, and G3) labeled in the top panel. FIG. 13 shows two sets of patterns, in which the (111), (200) spots in grain G2 are mirrored, across the plane parallel to (111), by (111), (002) in grains G1 and G3, forming a typical coherent TB pattern.

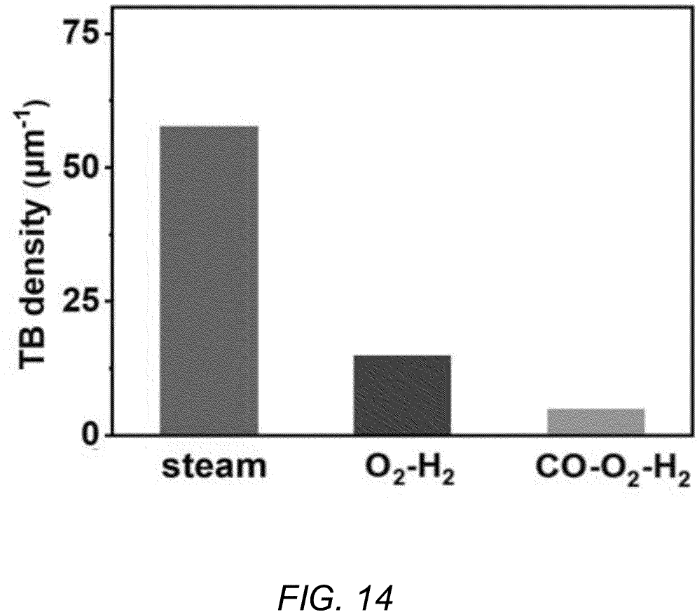

Many embodiments measure the TB surface density in order to assess the relation between the presence of TBs and catalytic activities. TB surface density can be calculated as the sum of the TB surface length over all measured NPs divided by the sum of the NP surface areas. Several embodiments provide that a higher the TB density can induce higher catalytic activities of nanoparticles. TB density statistical histogram of Pd/Al₂O₃ after steam (600° C.), O₂—H₂, and CO—O₂—H₂ treatment in accordance with an embodiment of the invention is illustrated in FIG. 14. The TB density is estimated to be about 58 µm⁻¹ for the steam-treated sample and about 15 µm⁻¹ for the O₂—H₂—pretreated sample. The steam treated catalyst shows higher catalytic activity compared to O₂—H₂—pretreated sample or CO—O₂—H₂ pretreated sample.

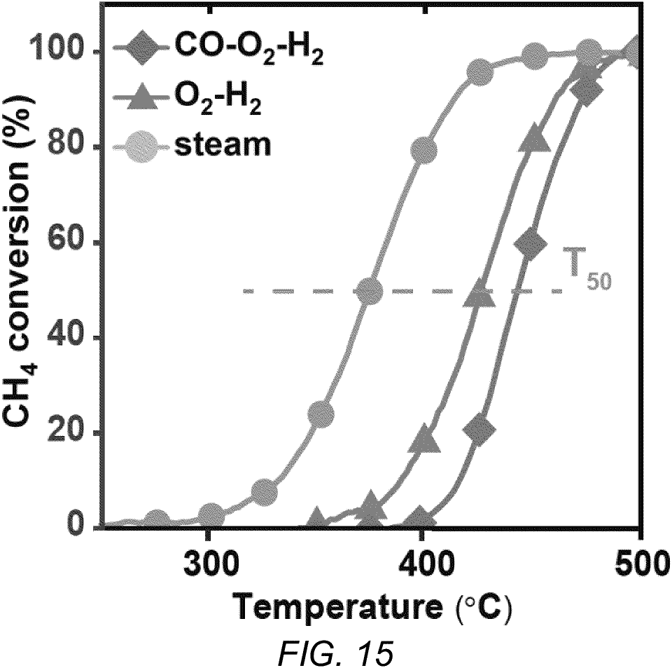

In certain embodiments, pristine Pd/Al₂O₃ samples can be subjected to dilute CO treatment to cause Pd NPs to restructure into vicinal stepped surfaces and decrease TB formation to confirm the role of TB density. The sample can be further subjected to O₂ and H₂ treatments to remove the carbon coating induced by the CO treatment, reduce the Pd to metallic state, and create a fully accessible and active Pd surface (CO—O₂—H₂—pretreated Pd/Al₂O₃). No appreciable change in NP size can be seen in TEM images, and XPS can confirm the metallic state of Pd. Light-off curves of Pd/Al₂O₃ after steam at about 600° C., O₂—H₂ and CO—O₂—H₂ pretreatments respectively in accordance with an embodiment is illustrated in FIG. 15. The CO—O₂—H₂—pretreated sample has a low TB density of about 4.9 µm⁻¹, and is also less active than both the steam-pretreated catalyst and the O₂—H₂ catalyst, with higher T₅₀ of about 446° C. as shown in FIG. 15.

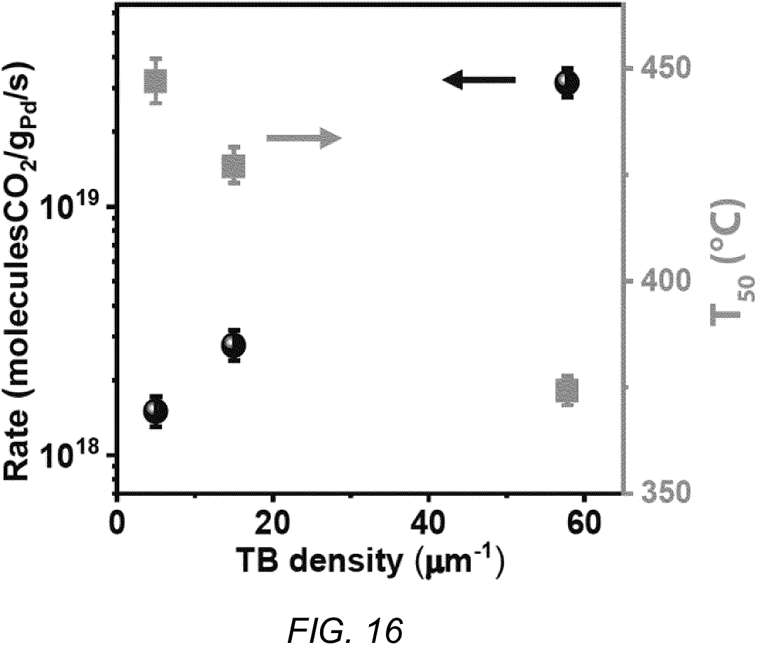

Many embodiments provide increased catalytic activities of the Pd/Al₂O₃ catalysts with TBs. Several embodiments provide the lack of TB formation under O₂, H₂, or CO atmospheres when compared to TB formation under steam. Relationship between reaction rate/T₅₀ and TB density in accordance with an embodiment is illustrated in FIG. 16. An intrinsic reaction rate can be calculated if the atoms at the TB for the measured TB density in the steam-pretreated sample accounted for the increase in rate. This rate is about 785 times greater than that on the in-plane Pd atoms.

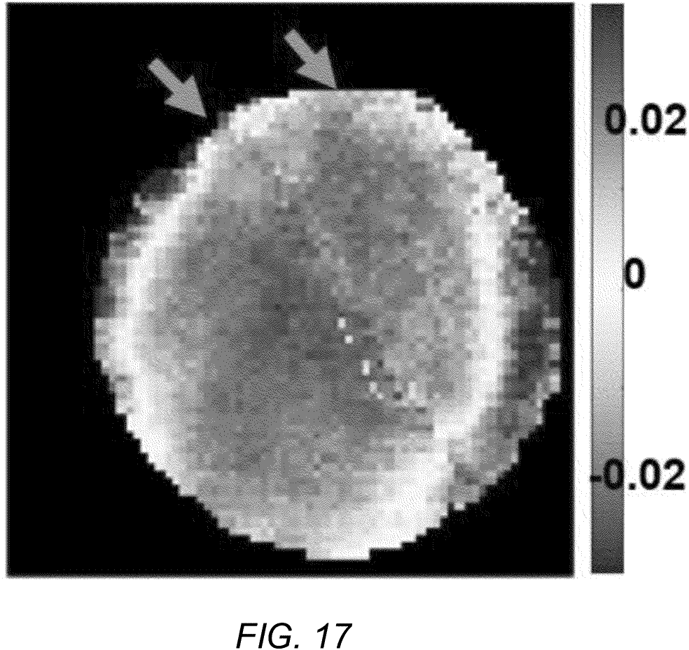

In many embodiments, enhanced catalytic activity associated with TBs could be related to strain effects given the presence of the GB. The exit-wave power-cepstrum (EWPC) transform can be applied to scanning nanobeam electron diffraction data to explore the distribution of lattice strain in the steam- and CO—O₂—H₂—pretreated Pd/Al₂O₃ catalyst. The strain values are relative to a reference value (Lagrange strain), which can be measured from the sum of all the diffraction patterns for individual NPs. Representative strain mapping for an individual Pd NP in the stream-pretreated catalyst relative to the reference values in the horizontal direction in accordance with an embodiment is illustrated in FIG. 17. The arrows denote the TBs in FIG. 17. Analysis reveals a radial lattice expansion near surfaces in both stream- and CO—O₂—H₂—pretreated samples regardless of the presence of a TB, and no correlation between the presence of a TB and a change in strain can be identified in the Pd samples.

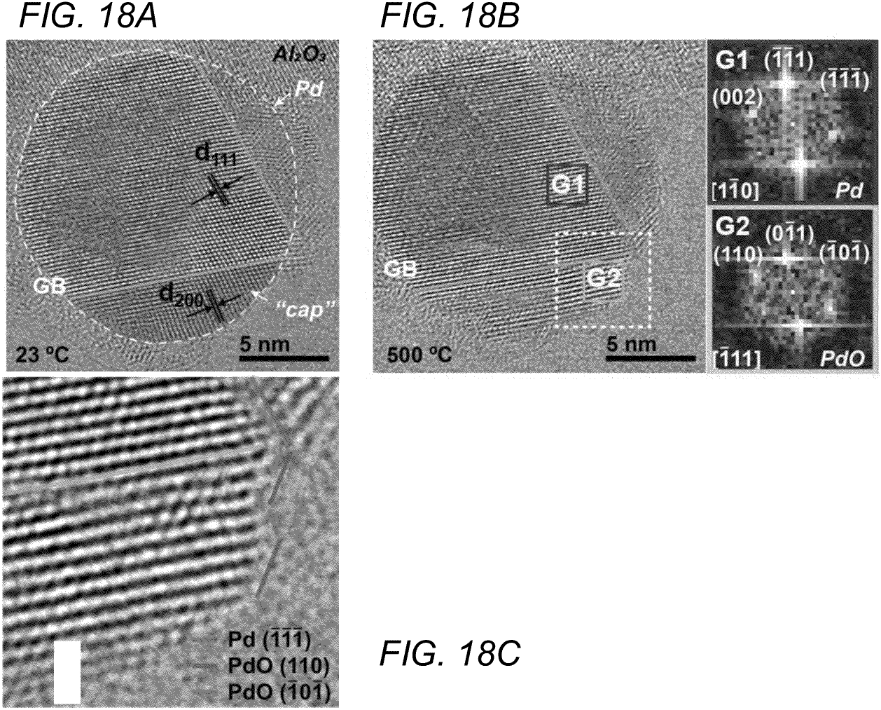

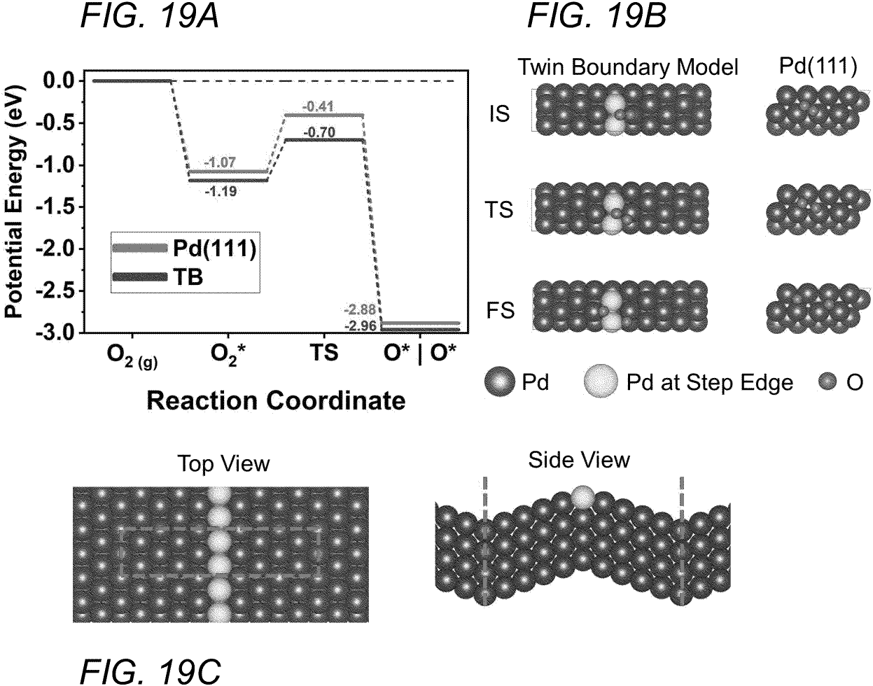

Several embodiments use environmental transmission electron microscopy (E-TEM) to determine the thermal stability of the TBs under oxidizing conditions. Initially, the Pd/Al₂O₃ can be exposed to an O₂ environment at a pressure of about 0.87 Pa at room temperature. The catalyst can be heated at a rate of about 100° C.·s⁻¹ and stabilized at about 500° C. No apparent boundary segregation or disappearance can be observed as annealing temperature increases. Instead, surface oxidation on the NP can be observed during this process: the “cap” separated by the {111} TB is preferentially oxidized, suggesting that the TB may promote oxygen dissociation and serve as the precursor structure to the formation of a GB between the Pd core and the surface PdO region. A slower heating rate experiment (at about 200° C.·min⁻¹) shows that the “cap” region can be preferentially oxidized at about 391° C. in the same O₂ environment. The PdO phase formation based on the FFT diffractogram in accordance with certain embodiments matches well with tetragonal PdO and suggests the oxidized “cap” region is oriented close to the [111] zone axis. The PdO surface is bounded by the (110) and (101) facets. Environmental TEM (E-TEM) images of the same Pd nanoparticle in the steam-pretreated Pd/Al₂O₃ sample exposed to O₂ at about 23° C. and about 500° C. respectively in accordance with an embodiment are illustrated in FIGS. 18A - 18C. The twin/grain boundaries are highlighted by lines in FIG. 18A and FIG. 18B. FFT diffractograms (insets in FIG. 18A) indicating that the “cap” region separated by GB is preferentially oxidized at about 500° C. FIG. 18C illustrates a zoom-in of the area marked by the white dashed box in FIG. 18B showing the exposed Pd and PdO facets in the vicinity of the GB.

Many embodiments provide that the original TB can be transformed into a general GB. Several embodiments provide that the planar defects can be maintained in an oxidizing condition at a high temperature of at least 500° C. The conversion of Pd to PdO transforms the crystalline lattice from cubic to tetragonal.

Some embodiments provide that formation of TBs can lead to an increased reaction rate. TBs may impart structural irregularities that induce reconstruction of the PdO surface. Further, linear and/or point defects at the vicinity of the TB can lead to improved C—H bond activation. Alternatively, the oxidation of the metal surface may generate strain in the Pd/PdO heterostructure and in the fully oxidized PdO NP containing the GB.

### EXEMPLARY EMBODIMENTS

Although specific embodiments of systems and methods are discussed in the following sections, it will be understood that these embodiments are provided as exemplary and are not intended to be limiting.

### Example 1: Synthesis of Palladium Nanoparticles With Different Sizes

Syntheses can be performed using Schlenk techniques. In a synthesis, Pd(acac)₂ (acac=acetylacetonate, 35% Pd) can be mixed with solvent mixture, Oleylamine (OLAM, 70%) and OLAC in a three-neck flask (Table 1). The mixture can be evacuated at room temperature for about 15 minutes under magnetic stirring. trioctylphosphine (TOP, 97%) can be added under evacuation and the mixture is heated to about 50° C. The solution can be left under vacuum for 30 minutes to remove water and other impurities. At this point, the reaction mixture is a transparent colored solution. The reaction flask can be then flushed with nitrogen and heated quickly (about 40° C. min⁻¹) to the desired temperature (Tᵣₓₙ). After 15 minutes of reaction at the appropriate temperature under magnetic stirring, the solution can be quickly cooled to room temperature by removing the heating mantle. The particles are purified three times by precipitation with a mixture of isopropanol, ethanol and methanol, and separated by centrifugation (838 rad/s (8000 rpm) for 3 minutes). A size selection is performed for 12 nm and 15 nm Pd sample before purification. Nanoparticles are first dispersed in 10 mL hexanes and 2 mL isopropyl alcohol (IPA), and then separated by centrifugation (838 rad/s (8000 rpm) for 3 minutes). Finally, the particles can be dispersed in hexanes producing a black solution and stored at room temperature. A small volume of OLAM (50 µL) can be used to ensure the complete redissolution of the particles. The sizes of nanoparticles are well controlled with a standard deviation less than 10%.

TABLE 1

Reaction conditions for the synthesis of Pd nanoparticles with different sizes

| Seed Size (nm) | Pd(acac)₂ (mmol) | Solvent Mixture (mL:mL) | OLAM (mL) | OLAC (mL) | TOP (mL) | Tᵣₓₙ (°C) |
|---|---|---|---|---|---|---|
| 8.0 nm | 0.25 | ODE : TDE = 6.6 : 3.4 | 3.4 | 0.8 | 2.4 | 290 |
| 12.0 nm | 0.25 | ODE = 5 | - | 5 | 0.56 | 250 |
| 15.0 nm | 0.25 | ODE = 5 | - | 5 | 0.56 | 280 |

### Example 2: Preparation of Supported Catalysts

Prior to impregnation, alumina can be prepared by calcining Puralox TH100/150 at about 900° C. for 24 hours using heating and cooling ramps of 5° C. min⁻¹ in static air (conventional Al₂O₃). Silica can be prepared by calcining silica gel (Davisil Grade 643; 200-425 mesh) at about 800° C. for 6 hours using heating and cooling ramps of 5° C. min⁻¹ in static air.

For impregnation of a desired loading of Pd nanoparticles onto Al₂O₃, metal concentrations of synthesized colloidal nanoparticle solutions can be determined via thermogravimetric analysis (TGA). Before TGA measurement, centrifugation ((838 rad/s (8000 rpm), 1 min) is applied to separate isolated nanoparticles and agglomerated nanoparticles. After removing the precipitate, a nanoparticle solution can be added dropwise into an aluminum TGA pan, which is heated via hot plate at about 80° C. until 150 µL has been added. This pan is then further heated in the TGA in flowing air to about 500° C., and held until a steady mass is reached, suggesting complete removal of organic molecules. Dividing this final mass by initial solution volume gives metal concentration. An appropriate amount of nanocrystals (to give a loading of 0.5 - 1.0% (by weight) of Pd in the final catalysts) dispersed in hexanes is added to a dispersion of stirred support (Al₂O₃ or SiO₂) in hexanes. Complete adsorption occurs immediately, and dispersions are left stirring for 5 - 10 minutes after particle addition. The solid is recovered by centrifugation ((838 rad/s (8000 rpm), 1 minute) and dried at about 60° C. overnight. Prior to catalytic tests, all samples are sieved below 180 µm grain size, treated in air at about 700° C. for 30 seconds (fast treatment) in a furnace to remove ligands from synthesis, and sieved again below 180 µm grain size to avoid effects of mass transfer limitations.

Support hydroxylation can be achieved by treating conventional Al₂O₃ at 600° C. for 0.5 hour under about 4.2% (by volume) H₂O in Ar (labeled as hydroxylated Al₂O₃). An appropriate amount of nanocrystals (to give a loading of 1.0% (by weight) of 8 nm Pd in the final catalysts) dispersed in hexanes is added to a dispersion of stirred support (conventional or hydroxylated Al₂O₃) in hexanes.

For the synthesis of the impregnation catalyst, 0.142 g of tetraamminepalladium nitrate (Pd(NO₃)₂·4NH₃, 10 wt. % in H₂O) is deposited onto 0.50 g of Al₂O₃ using incipient wetness impregnation. After impregnation, the product is dried in a vacuum oven at about 70° C. for 12 hours and calcined in air at about 500° C. in O₂ for 3 hours.

### Example 3: Different Gas Pretreatments

The heat pretreatment in an atmosphere of O₂, H₂, CO, or Ar can be carried out at a target temperature from about 300° C. to about 700° C. for about 30 minutes under the 25 ml min⁻¹ flow of 5% (by volume) O₂ in Ar, 5% (by volume) H₂ in Ar, 5% (by volume) CO in Ar, and pure Ar, respectively.

Steam pretreatment samples can be treated at about 600° C. for about 30 minutes under 4.2% (by volume) steam in Ar (25 ml min⁻¹ Ar-flow through a saturator with Milli-Q water at about 30° C.). The concentration of steam can be controlled by adjusting the saturator temperature. 0.8% (by volume) and 10% (by volume) steam can be achieved by cooling and heating the saturator at 4° C. and 47° C., respectively.

O₂—H₂ pretreatment can be carried out at about 600° C. for about 30 minutes under O₂ (5% (by volume))/Ar and subsequently reduced using 5% (by volume) H₂/Ar at 600° C. for 0.5 h. Steam-O₂ pretreatment can be carried out at about 600° C. for about 30 minutes under 4.2% (by volume) H₂O in Ar and subsequently oxidized at about 600° C. for about 30 minutes under O₂ (5% (by volume))/Ar. CO-O₂-H₂ pretreatment can be carried out first at about 675° C. for about 30 minutes under CO (5% (by volume))/Ar, then oxidized using 5% (by volume) O₂/Ar at about 600° C. for about 30 minutes, and subsequently reduced using 5% (by volume) H₂/Ar at about 600° C. for about 30 minutes.

### Example 4: Catalytic Activity of Pd Nanoparticles of Different Sizes

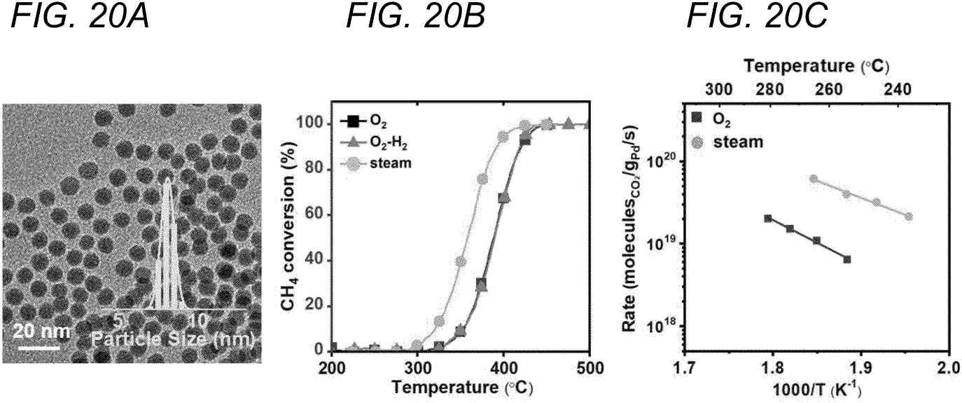

Activity enhancement by steam pretreatment in accordance with several embodiments can be applied to Pd nanoparticle catalysts of various sizes including (but not limited to) Pd/Al₂O₃ catalysts prepared from 4 nm, 8 nm, 12 nm, and 15 nm colloidal Pd NPs. A similar pretreatment-dependent activity profiles can be observed in a Pd/Al₂O₃ catalyst prepared by wet impregnation. TEM images of 8 nm Pd nanoparticles in accordance with an embodiment is illustrated in FIG. 20A. Insets shows size distribution of Pd nanoparticles with a Gaussian distribution centered around 8 nm. Methane combustion light-off curves for 8 nm Pd/Al₂O₃ catalysts after different pretreatments in accordance with an embodiment is illustrated in FIG. 20B. The 8 nm Pd/Al₂O₃ catalysts with steam treatment shows a highest CH₄ conversion efficiency compared to the catalysts with O₂ treatment and O₂—H₂ treatment. Arrhenius plots of dry combustion kinetics for Pd/Al₂O₃ catalysts after pretreatment in O₂ and steam at 600° C. in accordance with an embodiment is illustrated in FIG. 20C. The 8 nm Pd/Al₂O₃ catalysts with steam treatment shows higher rate compared to the catalysts with O₂ treatment.

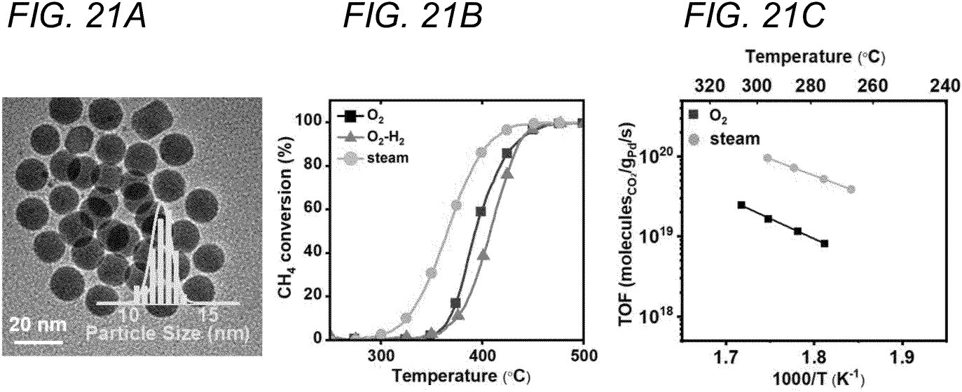

TEM images of 12 nm Pd nanoparticles in accordance with an embodiment is illustrated in FIG. 21A. Insets shows size distribution of Pd nanoparticles with a Gaussian distribution centered around 12 nm. Methane combustion light-off curves for 12 nm Pd/Al₂O₃ catalysts after different pretreatments in accordance with an embodiment is illustrated in FIG. 21B. The 12 nm Pd/Al₂O₃ catalysts with steam treatment shows a highest CH₄ conversion efficiency compared to the catalysts with O₂ treatment and O₂-H₂ treatment. Arrhenius plots of dry combustion kinetics for Pd/Al₂O₃ catalysts after pretreatment in O₂ and steam at 600° C. in accordance with an embodiment is illustrated in FIG. 21C. The 12 nm Pd/Al₂O₃ catalysts with steam treatment shows higher rate compared to the catalysts with O₂ treatment.

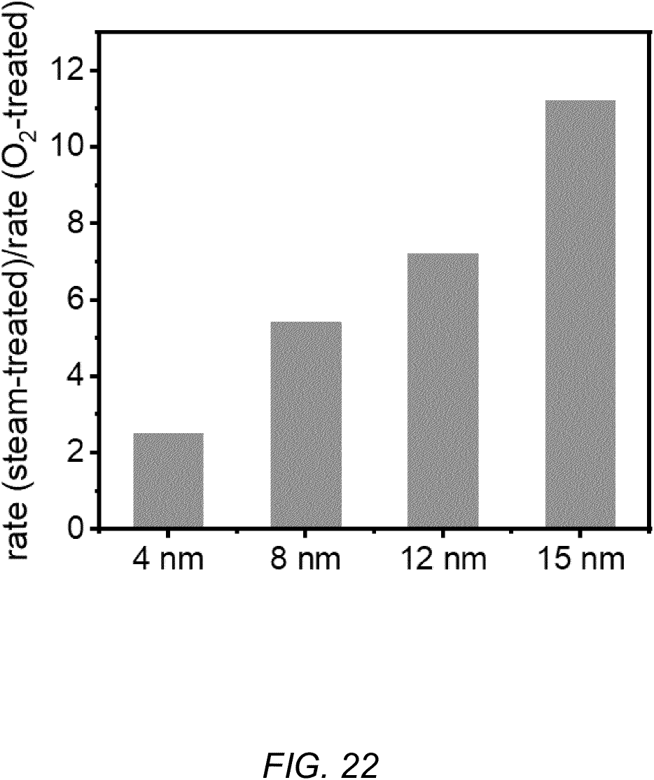

In many embodiments, the steam-pretreated catalysts exhibit higher activity than the O₂-pretreated catalysts. The NPs with a larger size show greater improvement in rates upon the steam treatment. Increase in reaction rates for Pd/Al₂O₃ catalysts of various sizes after steam pretreatment in accordance with an embodiment is illustrated in FIG. 22. In FIG. 22, 4 nm Pd Is prepared from wet impregnation, whereas the 8, 12 and 15 nm samples are prepared from colloidal nanoparticles. Increase in reaction rates can be calculated as rate (steam-pretreated catalyst) divided by rate (O₂-pretreated catalyst). The 15 nm NPs show a highest rate compared smaller sizes NPs as shown in FIG. 22. The size dependence may be explained by the more energetically favorable formation of TBs in larger NPs that can more easily accommodate defects.

### Example 5: Laser Ablation Processes

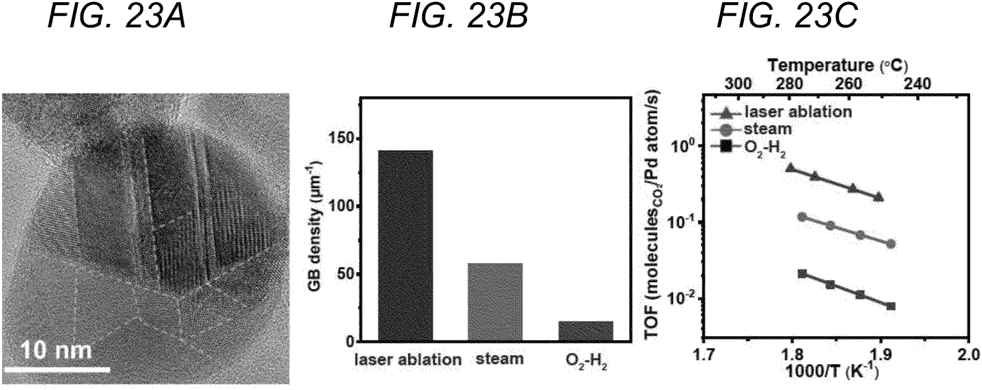

The formation of GBs as highly active sites for methane combustion in accordance with some embodiments provides the opportunity to engineer Pd/Al₂O₃ catalysts for improved reactivity if the density of such defects can be increased. Some embodiments provide laser ablation processes can be used to fabricate NPs rich in GBs. High-resolution TEM image of laser ablation-generated Pd NPs in accordance with an embodiment is illustrated in FIG. 23A. The dash lines highlight Σ3{111} TBs and GBs. GB density statistical histogram of laser-generated Pd/Al₂O₃ and Pd/Al₂O₃ after steam at about 600° C. and O₂—H₂ pretreatments in accordance with an embodiment is illustrated in FIG. 23B. Arrhenius plots of methane combustion of laser-generated Pd/Al₂O₃ and Pd/Al₂O₃ after steam at about 600° C. and O₂—H₂ pretreatments in accordance with an embodiment is illustrated in FIG. 23C. The turnover frequency (TOF) of the laser ablation-generated Pd/Al₂O₃ catalyst is about 4 times higher than that of the steam-pretreated Pd(15 nm)/Al₂O₃ catalyst, and hence nearly twenty-five times higher than a catalyst pretreated in just oxygen and hydrogen as shown in FIG. 23C.

Some embodiments provide preparation of Pd nanoparticles from laser ablation and supported catalysts. A ⅛″ thick, 1 inch diameter Pd sputtering target can be rinsed in acetone and deionized water. The target can be mounted into a threaded 2.54 cm diameter optical lens mount using two threaded retaining rings to keep the target standing on its edge during ablation. The mounted target is set into a 30 mL rinsed beaker and covered with 10 mL of deionized water, resulting in approximately 1 cm of water between the target and glass wall, before sealing the beaker mouth with aluminum foil. The assembly is set near a 50 mm focal length, anti-reflection coated, plano-convex lens, such that the Pd surface is normal to the optical axis and approximately one centimeter upstream of the lens’ focal point. This short focal-length lens is used to keep the intensity low at the glass surface. After checking the ablation point position on the target and for stray reflections with a few long pulse-mode laser pulses, the beaker is further encased in aluminum foil to minimize risks of inadvertent reflections, and the Pd can be ablated with nominally 8 ns to 12 ns full width half-maximum, Q-switched, 1064 nm, 0.3 J Nd:YAG laser pulses at about 10 Hz for about 20 minutes. Image analysis can be used to estimate the ovular pit area to be about 0.008 cm², which taken as the average area for the 0.3 J pulses yields an average fluence of 4·10² J·cm⁻².

10 ml of Pd nanoparticle solution can be added to a dispersion of stirred conventional Al₂O₃ in water (800 mg of Al₂O₃ in 40 ml of water) and further stirred for 5 h. Then, the supported particles can be collected by centrifugation (838 rad·s⁻¹ (8000 rpm), 30 min) and dried at 60° C. overnight.

### DOCTRINE OF EQUIVALENTS

As can be inferred from the above discussion, the above-mentioned concepts can be implemented in a variety of arrangements in accordance with embodiments of the invention. Accordingly, although the present invention has been described in certain specific aspects, many additional modifications and variations would be apparent to those skilled in the art. It is therefore to be understood that the present invention may be practiced otherwise than specifically described. Thus, embodiments of the present invention should be considered in all respects as illustrative and not restrictive.

What is claimed is:

1. A method to improve catalytic activity comprising:
providing at least one nanoparticle; and
applying a steam from at least one steam source to the at least one nanoparticle at a temperature of at least 300° C. for at least 30 minutes;
wherein the applied steam forms at least one twin boundary on the at least one nanoparticle, and the formation of the at least one twin boundary improves catalytic activity of the at least one nanoparticle.

2. The method of claim 1, wherein the at least one nanoparticle comprises palladium or platinum.

3. The method of claim 1, wherein the at least one nanoparticle is selected from the group consisting of a palladium nanoparticle, a colloidal palladium nanoparticle, a palladium nanoparticle supported on alumina, a palladium nanoparticle supported on silica, and a platinum nanoparticle.

4. The method of claim 1, wherein the at least one nanoparticle has a diameter from about 4 nm to about 15 nm.

5. The method of claim 1, wherein the steam has a water concentration of at least 0.8% by volume.

6. The method of claim 5, wherein the steam has a water concentration of about 0.8% by volume, of about 4% by volume, or of about 10% by volume.

7. The method of claim 1, wherein the steam is mixed with an inert gas.

8. The method of claim 1, wherein the steam is applied at about 600° C. for about 30 minutes.

9. The method of claim 1, further comprising applying an oxygen gas to the steam treated at least one nanoparticle.

10. The method of claim 1, wherein the steam treated at least one nanoparticle is a catalyst in a redox reaction.

11. The method of claim 1, wherein the steam treated at least one nanoparticle is a catalyst in a hydrocarbon combustion reaction.

12. The method of claim 11, wherein the catalyst improves mass-specific reaction rate for C—H activation in a methane combustion reaction by at least 12 times.
